(19) United States
(12) Patent Application Publication
(10) Pub. No.: US 2006/0282183 A1
(43) Pub. Date: Dec. 14, 2006

(54) Fishing assistance device

(76) Inventors: Michael A. Gutweiler, Baton Rouge, LA (US); David Paul Gutweiler, Baton Rouge, LA (US)

Correspondence Address: GLOBAL PATENTS, Suite 120, 838 W. Long Lake Road, Bloomfield Hills, MI, 48302, US

(21) Appl. No.: 11/153,273

(22) Filed: Jun. 14, 2005

(51) Int. Cl. G06F 17/00

(52) U.S. Cl. 700/90

(57) ABSTRACT

A fishing assistance device is disclosed. The fishing assistance device includes a housing and a microprocessor provided in the housing. The microprocessor is programmed to receive information regarding fishing conditions and information regarding selection of fishing lures and correlate this information with the information regarding selection of fishing lures to optimize fishing results for a particular type of fish.

### FIELD OF THE INVENTION

The present invention relates to fishing accessories. More particularly, the present invention relates to a fishing assistance device which accepts various inputs concerning fishing conditions and generates information on selection and presentation of bait to optimize fishing results.

### BACKGROUND OF THE INVENTION

Fishing is a favorite pastime for many persons. However, there are many variables such as weather, water temperature, tide and depth, as well as lure selection and presentation, which largely determine the success or failure of a fishing expedition. Many persons who would like to fish successfully do not have either the time to learn or properly evaluate such variables through experience or someone to teach them.

Therefore, a fishing assistance device is needed which is capable of receiving various inputs regarding fishing conditions such as weather, water temperature and tide and correlating these variables with the optimum bait to be used, the presentation of the bait and the depth of water to be fished in order to optimize fishing results for a particular type of fish.

### SUMMARY OF THE INVENTION

The present invention is generally directed to a fishing assistance device for optimizing fishing results for a particular type of fish. The fishing assistance device includes a housing and a microprocessor provided in the housing. The microprocessor is programmed to receive information regarding fishing conditions and information regarding selection of fishing lures and correlate this information with the information regarding selection of fishing lures.

### BRIEF DESCRIPTION OF THE DRAWINGS

The invention will now be described, by way of example, with reference to the accompanying drawings, in which:

FIG. 1 is a front perspective view of an illustrative embodiment of the fishing assistance device according to the present invention;

FIG. 2 is a cross-sectional view of the fishing assistance device, taken along section lines 2-2 in FIG. 1;

FIG. 3 is a sectional view of a detachable touch screen pen provided on the fishing assistance device, taken along section lines 3-3 in FIG. 1; and

FIG. 4 is a schematic diagram illustrating a microprocessor and various features connected to the microprocessor of the fishing assistance device.

### DETAILED DESCRIPTION OF THE INVENTION

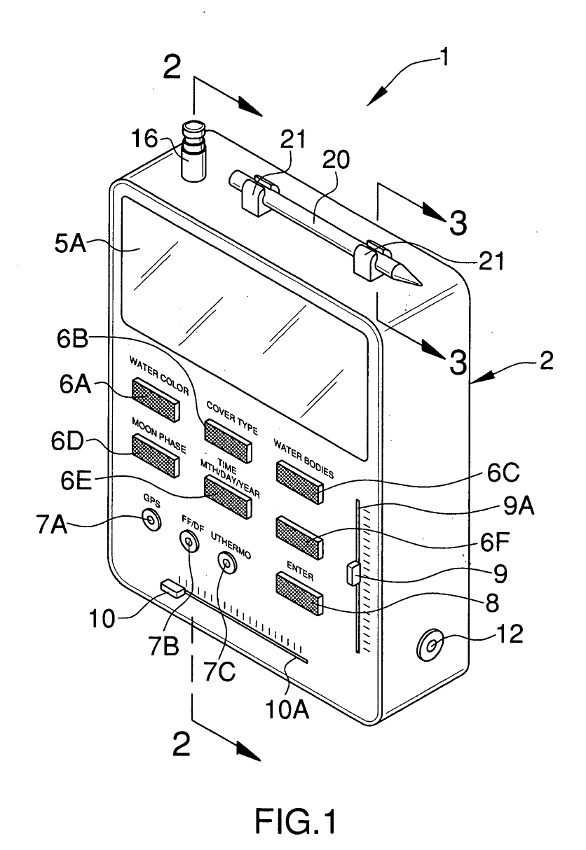

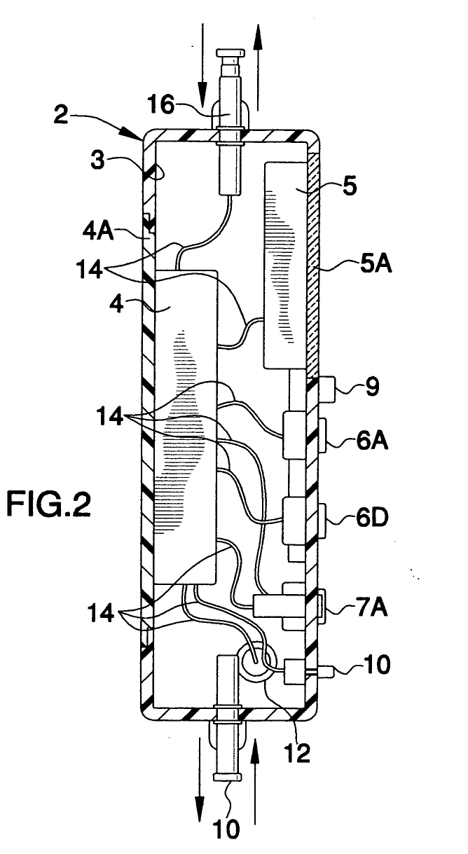

Referring to the drawings, an illustrative embodiment of the fishing assistance device, hereinafter device, according to the present invention is generally indicated by reference numeral 1. The device 1 includes a housing 2 having a housing interior 3, as shown in FIG. 2. The housing 2 is typically plastic or other waterproof material and may be any desired color, shape or size. A microprocessor 4 is provided in the housing interior 3. The microprocessor 4 is connected through wiring 14 to a display unit 5 having a touch screen 5a, which may be a liquid crystal display (LCD) screen, for example, on the outside of the housing 2, as shown in FIG. 1. As shown in FIG. 2, the microprocessor 4 may be mounted on a plate 4a which is detachable from the housing 2 to facilitate repair or maintenance of the microprocessor 4, as necessary.

Various function buttons 6 are provided on the housing 2, typically beneath the touch screen 5a. As shown in FIG. 1, these may include, for example, a “water color” button 6a; a “cover type” button 6b; a “water bodies” button 6c; a “moon phase” button 6d; a “time” button 6e; and an additional button 6f having a desired function. An “enter” button 8 may further be provided on the housing 2 and connected to the microprocessor 4 for entering information into the microprocessor, as will be hereinafter described. Each of function buttons 6 and the enter button 8 is connected to the microprocessor 4 through wiring 14.

A vertical screen scroll switch 9, which controls vertical scrolling of information displayed on the touch screen 5a, may be mounted in a slot 9a provided in the housing 2. Similarly, a horizontal screen scroll switch 10, which controls horizontal scrolling of information displayed on the touch screen 5a, may be mounted in a slot 10a provided in the housing 2. The vertical screen scroll switch 9 and the horizontal screen scroll switch 10 are connected to the microprocessor 4 by wiring 14. An antenna 16, which may be a telescopic antenna, for example, may be provided in the housing 2 and connected to the microprocessor 4 by wiring 14 to transmit information in the form of radio waves to the microprocessor 4. A water temperature probe 18 may further be provided in the housing 2 and connected to the microprocessor 4 by wiring (not shown).

As further shown in FIG. 1, various connection jacks may be provided in the housing 2. These may include, for example, a “GPS” jack 7a, an “FF/DF” jack 7b and an additional jack 7c of selected description. Each of the connection jacks 7 is connected to the microprocessor 4 through wiring 14. A power cord adaptor socket 12, which is capable of receiving a power cord (not shown) plugged into a standard 120-volt electrical outlet, may be provided on the housing 2 and connected to the microprocessor 4 by wiring 14.

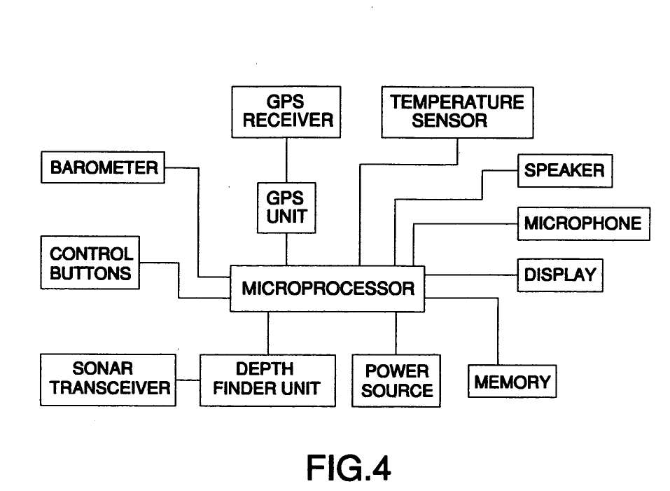

As shown in FIG. 4, a power source 32, such as a battery and/or solar cell, for example, may be connected to the microprocessor 4 instead of or in addition to the power cord adaptor socket 12. The microprocessor 4 further includes a memory 34 which is capable of containing a selected quantity of information. FIG. 4 further shows various operational features which may be connected to the microprocessor 4 in addition to the display unit 5, the control buttons 6 and water temperature probe 18 which were heretofore described with respect to FIGS. 1 and 2. These may include, for example, a GPS unit 24 which may be connected to the microprocessor 4 through the GPS jack 7a and includes a GPS receiver 25 which receives transmission signals from a GPS satellite (not shown); a depth finder unit 28 which may be connected to the microprocessor 4 typically through the “FF/DP” jack 7b (FIG. 1) and includes a SONAR transceiver 29 and transmits information regarding the depth of the water body or the location of fish in the water body to the microprocessor 4; a microphone 36 which may be used to speak information into the microprocessor 4; a speaker 38 which may broadcast information in an audible form from the microprocessor 4; and a barometer 40 which is capable of measuring the environmental or atmospheric barometric pressure and transmitting this information to the microprocessor 4.

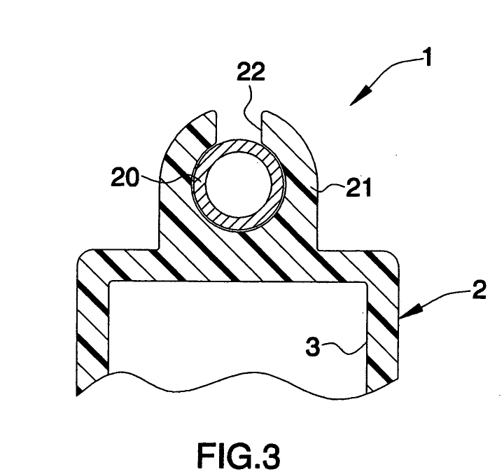

A pair of spaced-apart pen holders 21 may be provided on the housing 2. As shown in FIG. 3, the respective pen holders 21 include registering slots 22. Accordingly, a touch screen pen 20 may be removably inserted in the slots 22 of the respective pen holders 21 and secured therein when not in use. The touch screen pen 20 may be removed from the pen holders 21 and pressed against the touch screen 5a to select and/or enter various types of information into the microprocessor 4, as will be hereinafter further described.

The microprocessor 4 is programmed to receive various types of input regarding fishing conditions and correlate this information with the selection (lure type) and presentation (lure color and appearance) of lure which should be made by a user to optimize fishing results for a particular type of fish. Accordingly, in typical use of the device 1, various types of fish, one of which is to be sought during a fishing expedition, may appear on the touch screen 5a. The type of fish to be sought in the fishing expedition may be selected on the touch screen 5a using the touch screen pen 20, for example. The microprocessor 4 is then primed to receive information regarding the various fishing conditions which will exist during the fishing expedition for the selected type of fish. For example, the temperature of the water body to be fished can be entered into the microprocessor 4 by dipping the water temperature probe 18 in the water body. The barometric pressure at the water body can be measured by the barometer 40 and transmitted to the microprocessor 4. Various possible colors of the water body may be displayed on the touch screen 5a and selected by depressing the “water color” function button 6a. The actual color of the water body to be fished can be entered into the microprocessor 6a by pushing the “enter” button 8. In similar fashion, the user can select and enter information regarding the type of cover on the water body to be fished by pushing the “cover type” function button 6b and “enter” button 8, respectively. The user can select and enter information on the type of fishing water body to be fished into the microprocessor 6a by pushing the “water bodies” function button 6c and the “enter” button 8, respectively. Information regarding the moon phase during the fishing expedition can be selected and entered into the microprocessor 4 by pushing the “moon phase” function button 6d and “enter” button 8. Information regarding the time (typically in terms of the month, day and year) can be selected and entered into the microprocessor 4 by pushing the “time” button 6e and the “enter” button 8. Alternatively or additionally, the microprocessor 4 may be programmed in such a manner that the selected information can be entered into the microprocessor 4 by touching the information on the touch screen 5a using the touch screen pen 20. Furthermore, the information may alternatively or additionally be entered into the microprocessor 4 by speaking the information into the microphone 36 (FIG. 4) connected to the microprocessor 4.

After the various items of information regarding the fishing conditions are entered into the microprocessor 4, either by input through the touch screen 5a, the function buttons 6 and/or by self-readings through the barometer 40, the depth finder unit 28 and the temperature sensor 18, typically in the manner heretofore described, the microprocessor 4 correlates this information for the particular type of fish selected with the type of bait and presentation of bait which will yield optimum fishing results during the fishing expedition for that type of fish. This information is displayed on the touch screen 5a. Alternatively or additionally, the information may be broadcast from the speaker 38 (FIG. 4) connected to the microprocessor 4.

During the fishing expedition, a “fish finder” mode may be selected by touching the touch screen 5a with the touch screen pen 20. The depth finder unit 28, through the SONAR transceiver 29, transmits signals regarding the location of fish in the fishing water to the microprocessor 4. The microprocessor 4, in turn, displays this information on the touch screen 5a. Alternatively or additionally, the microprocessor 4 may use the information provided by the depth finder unit 28, in addition to the other information regarding fishing conditions, to determine the type of bait and bait presentation which is optimal for the type of fish to be sought during the fishing expedition. Furthermore, the device 1 may be provided with a global positioning capability in which the GPS unit 24, through the GPS receiver 25, monitors the location of the device 1 and the microprocessor 4 indicates this information on the touch screen 5a. Alternatively or additionally, the microprocessor 4 may use the information provided by the GPS unit 24, in addition to the other information regarding fishing conditions, to determine the type of bait and bait presentation which is optimal for the type of fish to be sought during the fishing expedition.

In addition to presenting information on the best type of bait to be used for a particular type of fish under particular fishing conditions, as was heretofore described, the microprocessor 4 may be programmed to correlate the proper line weight and lure of sinker weight for a particular size of fishing pole to be used in order to attain the desired fishing depth, and indicate this information on the touch screen 5a. The microprocessor 4 may further be programmed with a tutorial program in which the types of knots for different types of lures are presented on the touch screen 5a, as well as advice on when and how often to change lures when fishing. Furthermore, the microprocessor 4 may include the capacity to log and store the user's success during fishing expeditions. This allows the user to record his or her findings against a professional angler's findings and find a pattern for future reference. The device 1 may be internet-compatible such that the user may be able to download fishing information regarding the particular body of water he or she wishes to fish into the microprocessor 4.

While the preferred embodiments of the invention have been described above, it will be recognized and understood that various modifications can be made in the invention and the appended claims are intended to cover all such modifications which may fall within the spirit and scope of the invention.

What is claimed is:

1. A fishing assistance device comprising:
a housing;
a microprocessor provided in said housing; and
wherein said microprocessor is programmed to receive information regarding fishing conditions and information regarding selection of fishing lures and correlate said information regarding fishing conditions with said information regarding selection of fishing lures.

2. The fishing assistance device of claim 1 further comprising a display carried by said housing and connected to said microprocessor and wherein said display is adapted to display said information regarding selection of fishing lures.

3. The fishing assistance device of claim 2 wherein said display comprises a touch screen.

4. The fishing assistance device of claim 3 further comprising a pen holder carried by said housing and a touch screen pen detachably carried by said pen holder.

5. The fishing assistance device of claim 1 further comprising a plurality of function buttons carried by said housing and connected to said microprocessor for entering said information regarding fishing conditions into said microprocessor.

6. The fishing assistance device of claim 1 further comprising a speaker connected to said microprocessor for audibly broadcasting said information regarding selection of fishing lures.

7. The fishing assistance device of claim 1 further comprising a barometer connected to said microprocessor.

8. The fishing assistance device of claim 1 further comprising a water temperature probe carried by said housing and connected to said microprocessor.

9. A fishing assistance device comprising:
a housing;
a microprocessor provided in said housing;
wherein said microprocessor is programmed to receive information regarding fishing conditions and information regarding selection of fishing lures and correlate said information regarding fishing conditions with said information regarding selection of fishing lures;
a display carried by said housing and connected to said microprocessor and adapted to display said information regarding selection of fishing lures; and
a global positioning system unit connected to said microprocessor.

10. The fishing assistance device of claim 9 wherein said display comprises a touch screen.

11. The fishing assistance device of claim 10 further comprising a pen holder carried by said housing and a touch screen pen detachably carried by said pen holder.

12. The fishing assistance device of claim 9 further comprising a plurality of function buttons carried by said housing and connected to said microprocessor for entering said information regarding fishing conditions into said microprocessor.

13. The fishing assistance device of claim 9 further comprising a speaker connected to said microprocessor for audibly broadcasting said information regarding selection of fishing lures.

14. The fishing assistance device of claim 9 further comprising a barometer connected to said microprocessor.

15. The fishing assistance device of claim 9 further comprising a water temperature probe carried by said housing and connected to said microprocessor.

16. A fishing assistance device comprising:
a housing;
a microprocessor provided in said housing;
wherein said microprocessor is programmed to receive information regarding fishing conditions and information regarding selection of fishing lures and correlate said information regarding fishing conditions with said information regarding selection of fishing lures;
a display carried by said housing and connected to said microprocessor and adapted to display said information regarding selection of fishing lures;
a plurality of jacks provided in said housing and connected to said microprocessor; and
a global positioning system unit connected to one of said plurality of jacks.

17. The fishing assistance device of claim 16 wherein said display comprises a touch screen.

18. The fishing assistance device of claim 16 further comprising a plurality of function buttons carried by said housing and connected to said microprocessor for entering said information regarding fishing conditions into said microprocessor.

19. The fishing assistance device of claim 18 wherein said plurality of function buttons comprises a water color function button, a cover type function button, a water bodies function button, a moon phase function button and a time function button.

20. The fishing assistance device of claim 19 further comprising a barometer and a water temperature probe carried by said housing and connected to said microprocessor.
